(19) United States
(12) Patent Application Publication
(10) Pub. No.: US 2007/0023588 A1
(43) Pub. Date: Feb. 1, 2007

(54) PORTABLE SUPPORT FOR A CLOSURE

(76) Inventor: Paul S. Symons, Cornwall (GB)

Correspondence Address: GIFFORD, KRASS, GROH, SPRINKLE & CITKOWSKI, P.C, PO BOX 7021, TROY, MI, 48007-7021, US

(21) Appl. No.: 11/457,232

(22) Filed: Jul. 13, 2006

(30) Foreign Application Priority Data
Jul. 13, 2005 (GB) GB 0514363.1

(51) Int. Cl. F16M 11/00

(52) U.S. Cl. 248/125.7

(57) ABSTRACT

A temporary, dismountable or reusable portable post (2) for a closure (21), such as a gate, comprises a base (1) for carrying the post (2), wherein the post has at least one pivotal connector (13) for connecting to the closure (21). The pivotal connector (13) is axially adjustable along the post so that it is possible to align a pair of adjacent closures (21) even if the base (1) of one is at a different level from the other. This may be achieved by the post including a threaded bar (12) on which the pivotal connector (13) is provided.

### FIELD OF THE INVENTION

This application relates to an adjustable, portable support for a closure, and in particular, a temporary gatepost.

### BACKGROUND OF THE INVENTION

There are many situations where it is necessary to provide a temporary secure compound in the open-air. For example, building sites often require a compound to keep the general public out for both safety reasons and for security reasons. Such compounds typically comprise fencing and at least one gateway. The fencing may be formed of either wooden panels (e.g. plywood sheets) or metal mesh or possibly even galvanised steel palisade fencing. The panels may be supported by metal (e.g. steel) frames. At some point in the perimeter of the fencing an entrance/exit is typically required. Such entrance/exits often need to have closures such as doors or gates.

In addition to open-air compounds there is often a requirement for temporary internal walls and doorways, for example in exhibition centres or conference halls where many different exhibitors or delegates are present and there is a need for secure temporary areas for use as offices or store rooms.

Traditionally, permanent supports for internal closures, such as doors or windows, are fixed to walls with nails, and/or screws. Further, supports for external closures are traditionally fixed into the ground by excavating a hole and then securing the support in the hole by either rammed earth or concrete. This method of fixing the supports is consequently time consuming, expensive and makes the re-use of the support difficult if not impossible.

Typically, supports for closures take the form of a post upon which at least one pivotal connector is fixed. The pivotal connector allows the closure to be pivoted open and closed whilst being held spaced from the ground. Such pivotal connectors are usually fixed to the support in pre-set positions. The pivotal connector may be a pivot pin or a hinge. For instance, traditional door-style hinges with two interlocked leaves and a central pin may be used.

Since the ground around temporary open-air compounds is often uneven, the pivotal connectors may not be level across the gate opening when the supports are fixed in place and accordingly the gates may hang at different heights. This makes it difficult to lock the gates closed. Further, the gates may not open or close properly due to the uneven ground and the fixed nature of the pivotal connectors. For instance, the gate may strike the ground.

Uneven ground is not normally a problem within the inside of buildings such as in exhibition centres. However, there is a need for a faster and more temporary adjustable closure support to cater for the different environments, door sizes, and particular requirements of temporary indoor use and to allow for fast and easy installation.

### SUMMARY OF THE INVENTION

In one aspect, the invention provides a portable support for a closure comprising a base for carrying an elongate support member having at least one pivotal connector for connecting the closure to the elongate support member in which the at least one pivotal connector is adjustable axially of the elongate support member.

A feature of the present invention is that the pivotal connector which supports the closure is adjustable in its position along the axial length of the support member. Accordingly, even though two associated support members may be at different levels due to uneven ground the closures themselves may be hung at an identical level to each other by adjusting the corresponding pivotal connector on each support member.

In one embodiment, there is more than one pivotal connector to allow the support of heavier closures and to provide better control over the closures' movement. The axial position of at least one of the pivotal connectors is adjustable to allow for a range of hinge spacings on the associated closures.

In another embodiment, the axial position of at least two of the pivotal connectors is adjustable to allow a greater degree of control over the position and height of a closure supported thereby.

In yet another embodiment, the axial position of the at least two pivotal connectors is adjustable in the same and/or opposite directions. This allows even greater freedom of movement of the pivotal connectors to accommodate different hinge spacings on associated closures, uneven ground, differently sized closures, etc.

Further embodiments are described in the dependent Claims attached hereto.

### BRIEF DESCRIPTION OF THE DRAWINGS

The present invention will be further described and explained with reference to the accompanying drawings in which:

FIG. 1 shows a perspective view of a base unit;

FIG. 2 shows a perspective view of a support member,

FIG. 3 shows a perspective view of another support member,

FIG. 4 shows a perspective view of yet another support member,

FIG. 5 shows a perspective view of a yet further support member,

FIG. 6 shows a side-view of one embodiment of a pivotal connector, and

FIG. 7 shows a perspective view of a gateway.

### DETAILED DESCRIPTION OF THE PREFERRED EMBODIMENTS

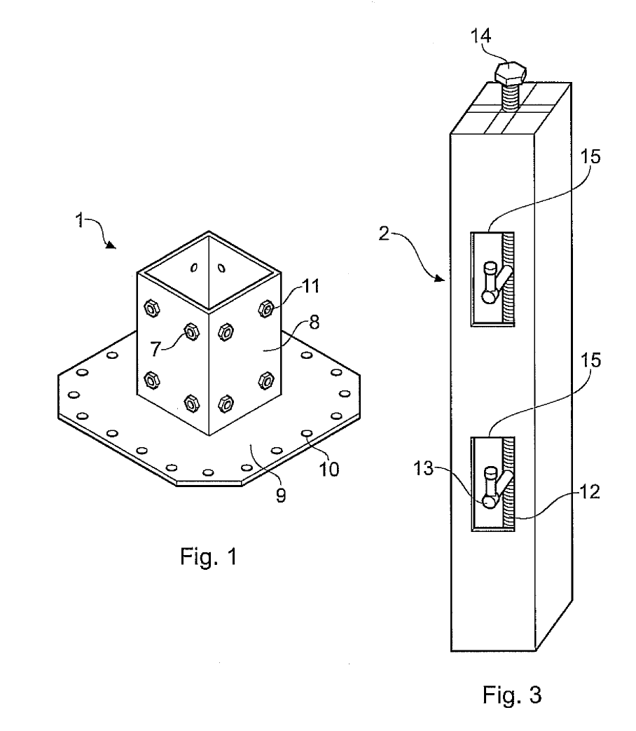

In FIG. 1 it may be seen how the base 1 comprises a base plate 9 and a receptacle in the form of a box 8 attached thereto. The base plate 9 has several holes 10 provided therethrough and arranged around the perimeter of the base plate 9. Further, holes 7 are provided through the sides of the box 8. In the embodiment shown, a nut 11 is fixed to each hole 7.

In FIG. 2, a support member 2 is shown in perspective view. In this embodiment, the cross section of the support member 2 is approximately square. However, it would of course be possible to have a variety of shapes of cross sections, for instance, a circular cross section would work equally well.

Provided through the axial length of the post 2 is a threaded bar 12. This threaded bar is fixed at each end to the post 2. However, the threaded bar 12 is rotatable within the post 2. This could be achieved, for example, by means of a circular collar surrounding the bar at each end and fixed to the post such that the collar is large enough to allow the bar to rotate but small enough to prevent the bar from moving laterally within the support member.

Provided in one side of the post 2 is an openings 15. Further, a pivotal connector 13 is provided in threaded association with the threaded bar 12. This pivotal connector 13 projects through the openings 15.

In use, the base 1 is placed on the ground and fixing means are forced through the holes 10 and into the ground below the base plate 9 to fix the base 1 to the ground. Such fixing means could comprise of smooth metal pins or threaded ground screws or expansion bolts etc.

Once the base is in position, the support member 2 is dropped into the box 8. Bolts are then screwed into the nuts 11 and through the holes 7 so that they press against the support member 2 and until the support member 2 is at its desired orientation (normally vertical). Although nuts 7 and bolts have been described other means of removably fixing the support member 2 into the box 8 are possible. For example, it could be possible to use wedges driven into the side of the box along the axial length of the support member 2.

With the support member 2 fixed to the base 1 the pivotal connector 13 may be adjusted axially along the length of the support member 2. This is carried out by means of rotation of the threaded bar 12. This may be achieved, for example, by means of the provision of a nut 14 fixed to the top of the threaded bar 12 and a spanner to turn the nut.

Although the base 1 is shown as separate from the support member 2, the two items could be pre-fabricated as one item. This would avoid the necessity of having to fix the support member 3 into the base 1.

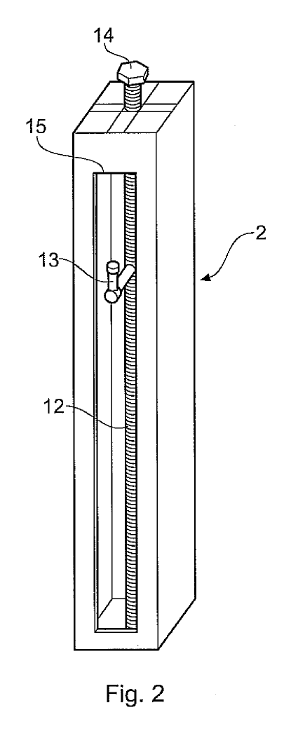

In FIG. 3, a support member 3 is shown with two openings 15 and two corresponding pivotal connectors 13 projecting therethrough. The number of openings and pivotal connectors may vary as to requirements and there is no upper limit on their number.

To adjust the axial position of the pivotal connectors 13 the nut 14 is turned so that the threaded bar 12 also rotates relative to the support member 2. Since the pivotal connectors 13 cannot rotate relative to the support member 2 due to the fact that they project through the openings 15 they will rise or fall relative to the support member 2 and respectively with the direction of rotation of the nut 14.

In one embodiment, the threaded bar 12 could have a right-handed thread in the upper half and a left-handed thread in the lower half. When the nut 14 is turned in this situation the upper and lower pivotal connectors 13 will travel axially away from each other or towards each other depending on the direction of rotation of the nut 14. It is also contemplated that any number of lengths of right and left-handed threaded bars could be arranged together axially and corresponding pivotal connectors 13 provided with corresponding openings 15 to achieve the desired result.

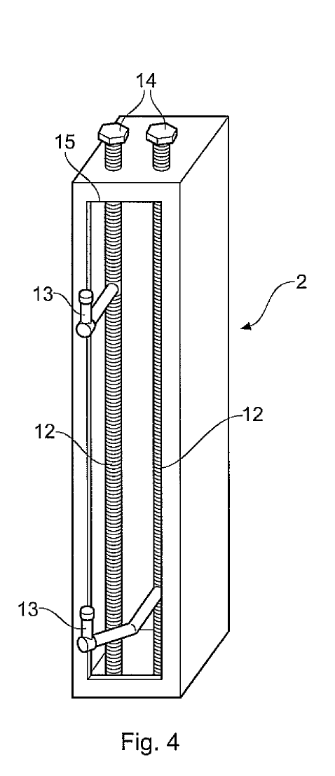

Another way of achieving the independent axial movement of different pivotal connectors 13 within the same support member 2 is shown in FIG. 4. Here, there are two threaded bars 12 each with a pivotal connector 13. To ensure a consistent axis upon which the associated closure is supported the pivotal connectors 13 have different lengths and orientations. For instance, in the figure it is seen that the lower pivotal connector is bent over so that the actual point at which the closure is hung on the lower pivotal connector is directly below the same point on the upper pivotal connector.

By the presence of two threaded bars 12 the axially position of each pivotal connector 13 can be adjusted independently. By increasing the number of threaded bars the number of pivotal connectors which can have their axial position adjusted may also be increased.

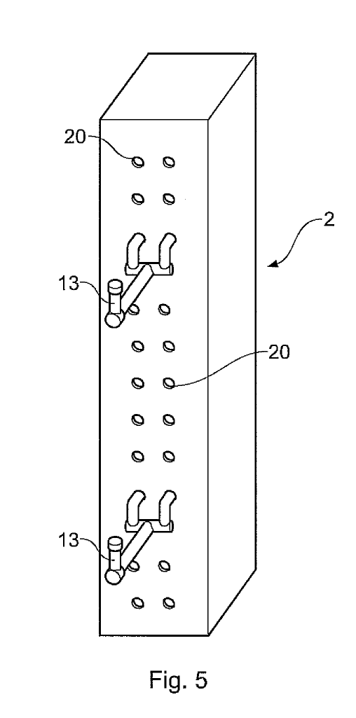

In FIG. 5 another embodiment is shown. The support member 2 has a series of a pair of holes 20 along one surface. The axial position of the pivotal connectors 13 may be adjusted by hooking them into a selected pair of holes 20.

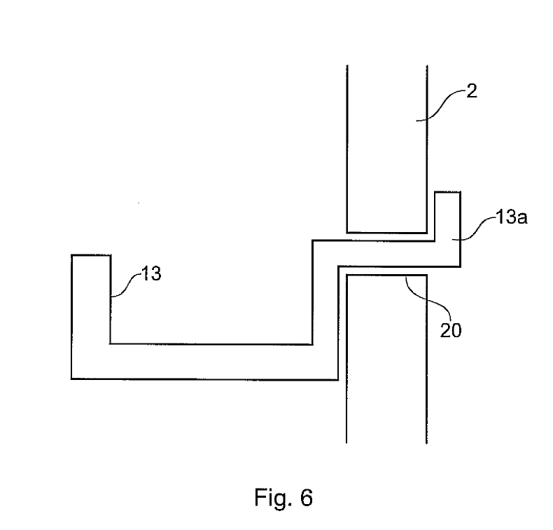

FIG. 6 shows a side-view of a pivotal connector 13 which could be used with such a support member 2. As may be seen, one end of the pivotal connector has two hook parts 13a which fit through the holes 20. The holes 20 are large enough to allow the pivotal connector 13 to be fitted this way but small enough to prevent the pivotal connectors 13 from being pulled out during use.

There are of course limitless ways of adjusting the axial position of pivotal connectors with associated support members.

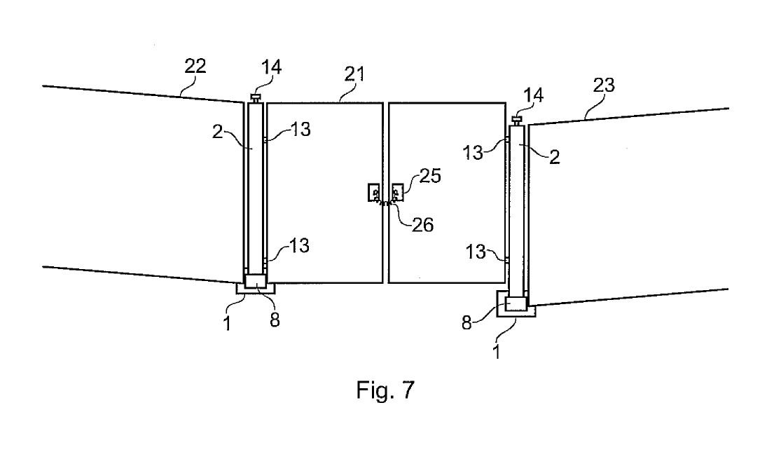

In FIG. 7 a perspective view of a gateway, at a building site for instance, is shown. The ground level of the right hand side is lower than the left hand side and accordingly the pivotal connectors 13 on the right hands side support member 2 have been adjusted upwards by use of the nut 14. This allows the two gates 21 to hang level with one another. This makes it easier to line up the two holes 25 such that the gates can be locked with a chain and padlock 26. Further, it allows the right hand side gate to open and close properly without fouling the uneven ground below. Both support member 2 are held in place with their associated base units 1. Hoardings 22,23 are shown extending away from each support member 2.

In one embodiment, the portable support member system may be fabricated from steel such that the box 8 is welded to the base plate 9 and the nuts 7 are welded to the box 8. However, other materials could be employed for the manufacture of the portable support member system. For instance HDPE could be employed.

1. A portable support for a closure comprising a base for carrying an elongate support member having at least one pivotal connector for connecting the closure to the elongate support member in which the at least one pivotal connector is adjustable axially of the elongate support member.

2. A portable support for a closure according to claim 1, wherein the support member comprises at least two pivotal connectors, and wherein at least one pivotal connector is adjustable axially of the elongate support member.

3. A portable support for a closure according to claim 2, wherein the at least two pivotal connectors are adjustable axially of the support member.

4. A portable support for a closure according to claim 3, wherein the at least two pivotal connectors are adjustable axially of the support member in the same and/or opposite directions.

5. A portable support for a closure according to claim 1, wherein the support member is removably fixable to the base.

6. A portable support for a closure according to claim 5, wherein the base comprises a base plate and a receptacle adequately sized for receiving the support member.

7. A portable support for a closure according to claim 6, further comprising means for retaining the support member in the receptacle.

8. A portable support for a closure according to claim 5, further comprising means for fixing the base plate to the ground.

9. A portable support for a closure according to claim 1, wherein the support member is hollow and has means for axial adjustment of the pivotal connector(s).

10. A portable support for a closure according to claim 9, wherein the means for axial adjustment of the pivotal connector(s) comprises at least one threaded bar rotatably fixed axially through the elongate support member.

11. A portable support for a closure according to claim 9, wherein the pivotal connector(s) is/are threaded rotatably to the at least one threaded bar.

12. A portable support for a closure according to claim 1, wherein the pivotal connector is a hinge pin.

13. (canceled)
